(19) United States
(12) Patent Application Publication
(10) Pub. No.: US 2004/0006495 A1
(43) Pub. Date: Jan. 8, 2004

(54) Letter communication method, an apparatus, and a computer program product for a healthcare provider to effectively expedite reimbursement process from a patient

(75) Inventor: James D. Dudley, Naperville, IL (US)

Correspondence Address: Charles F. Meroni, Jr., Meroni & Meroni, A Professional Corporation, P.O. Box 309, Barrington, IL, 60011, US

(73) Assignee: JDA eHealth Systems, Inc.

(21) Appl. No.: 10/187,527

(22) Filed: Jul. 2, 2002

(51) Int. Cl. G06F 17/60

(52) U.S. Cl. 705/3

(57) ABSTRACT

This invention concerns a letter communication method for a healthcare provider to effectively expedite reimbursement process from a patient. The letter communication method comprises gathering a current information, categorizing the patient into a group, processing the current information, generating a processed information, producing the letter, sending the letter to the patient, and updating the current information of the patient. The various steps of the letter communication method can be repeated. The letter communication method further comprises identifying a payment method chosen by the patient, calculating a past due period, and generating the letter according to a pre-defined formula, the pre-defined formula having at least the payment method and the past due period as variables. The letter generated by the letter communication method informs the patient the current information and a future action of the healthcare provider at a future date.

### BACKGROUND OF THE INVENTION

1. Field of the Invention

The present invention relates to a payment collection letter system for healthcare providers, which includes method, apparatus and computer program products. More specifically, my invention is primarily intended for use by healthcare providers to communicate with the patients about their payments status. My invention includes multiple letters to be generated and sent to the patients by the healthcare providers.

2. Description of the Prior Art

Healthcare providers are providing necessary healthcare to the people of this country around the clock. Due to the ever increasing complexity of the insurance systems of this country, healthcare providers need very sophisticated computer system and database to help themselves to manage various healthcare related data. In order to help healthcare providers to successfully manage their healthcare related information system, the prior art reveals a lot of methods and apparatus as in the following U.S. patents.

U.S. Pat. No. 6,205,455, which issued to Umen, et al., discloses a Drug Document Production System. A document production system is provided for preparing documents and managing a database of information pertaining to investigational studies of medical products. The document production system includes a data management user interface for providing user access to the database and for retrieving information from the database as specified by selected document templates for placement into word processor-compatible documents. Additionally, the data management user interface is capable of updating information stored within the database in accordance with information specified within a previously-prepared document.

U.S. Pat. No. 6,182,047, which issued to Dirbas, discloses a Medical Information Log System. A computer system is provided in this patent having a medical information log system. A mouse and/or a keyboard is used to input data for various medical log entries. These log entries are associated with a medical visit, and they contain information related to the doctor and the type of the medical visit. Each medical visit has only one log entry associated with it. The inputted data is stored within an organized database located in the computer's memory. The computer's controller is used to track the inputted data for various desired information. This information can be used for record keeping, outcome analysis, research, teaching, quality assurance, and/or billing. The inputted data is displayed on display when desired.

U.S. Pat. No. 6,125,350, which issued to Dirbas, discloses Medical Information Log System. A computer system is provided in this patent having a medical information log system. A mouse and/or a keyboard is used to input data for various medical log entries. These log entries are associated with a medical visit, and they contain information related to the doctor and the type of the medical visit. Each medical visit has only one log entry associated with it. The inputted data are stored within an organized database located in the computer's memory. The computer's controller is used to track the inputted data for various desired information. This information can be used for record keeping, outcome analysis, research, teaching, quality assurance, and/or billing. The inputted data are displayed on display when desired.

U.S. Pat. No. 5,974,389, which issued to Clark, et al., discloses a Medical Record Management System and Process with Improved Workflow Features. A patient medical record system includes a number of caregiver computers, and a patient record database with patient data coupled to the caregiver computers selectively providing access to the patient data from one of the caregiver computers responsive to a predetermined set of access rules. The predetermined set of rules includes a rule that access to a predetermined portion of the patient data by a first caregiver must be terminated before access to the same predetermined portion by a second caregiver is allowed.

U.S. Pat. No. 5,915,240, which issued to Karpf, discloses a Computer System and Method for Accessing Medical Information Over a Network. This patent discloses a Medical Lookup Reference computer system for accessing medical information over a network. The system partitions the functioning of the system between a client and server program in an optimal manner to assure synchronization of the master medical information databases on the servers with the local medical information database on the client, minimize the use of network resources, and allow new types of medical information to be easily included in the system. A server site on the network maintains a description of its medical information, as well as the most current and up-to-date medical reference information. The client program maintains a local database which is automatically synchronized over the network with revisions and new medical information, and provides a user with an interface to fully review the information in the database. The system also uses a context-sensitive call facility so that users of the Medical Lookup Reference program can easily get further expert assistance about the medical topic. The call feature uses the network connection to establish a conversation between the user and a person at a help site specified by the type of medical information they are currently referencing. Once a connection is established, the system allows the user to engage in a conversation with the person at the help site, and a record of the conversation can be saved in a database for auditing purposes.

U.S. Pat. No. 5,911,687, which issued to Sato, et al., discloses a Wide Area Medical Information System and Method Using Thereof. This patent discloses a wide area medical information system having a wide area network. A plurality of doctor terminals and patient terminals are connected to the wide area network. A management server includes at least an electronic case record file which stores clinic information for patient's and a doctor database storing data of a plurality of doctors, wherein the system searches the doctor database on the basis of patient information including the condition of the disease of a certain patient input from the patient terminal, selects the corresponding doctor, requests that the selected doctor take charge of examination and treatment for the aforementioned certain patient, registers the correspondence between the approved doctor and the aforementioned certain patient in the electronic case record file, gives the right to access the clinic information of the patient to the approved doctor, and executes the online examination and treatment via the doctor terminal and patient terminal, so that a patient existing in a wide area can receive remote examination and treatment services of high satisfaction and medical treatment related services other than examination and treatment without depending on the location.

U.S. Pat. No. 5,546,580, which issued to Seliger, et al. Discloses a Method and Apparatus for Coordinating Concurrent Updates to a Medical Information Database. The patent discloses a method for coordinating updates to a medical database in a medical information system permits concurrent charting from different workstations and medical instruments. A first data value for a record is entered at a first workstation and a second data value for the record is entered at a second workstation without locking either workstation during data entry. The new data values are stored in the medical database after completion of data entry at each workstation, and a correction history is recorded. The correction history contains information as to the update of the record with the first data value and the second data value. The record is updated with the first and second data values without aborting user activities or notifying a user that an update conflict has occurred. After the new data values are stored in the medical database, all workstations containing a copy of the record are updated to reflect the current state of the record.

U.S. Pat. No. 5,519,607, which issued to Tawil, discloses an Automated Health Benefit processing System. The system includes a database and three processors. The database includes the benefit payable to an insured, a list of providers available to perform the designated procedure, and each provider's charge for performing the designated procedure. The first processor generates a treatment plan concerning the insured that specifies the identity of the insured and the medical procedures to be performed on the insured. The first processor also accesses the database to retrieve the information stored in the database under the medical procedures to be performed and to append this information to the treatment plan. The second processor generates a treatment record specifying the medical procedures actually performed by a provider and the provider's actual charge therefor. The third processor processes the information in the treatment plan and treatment records to determine amounts payable to the insured and the provider.

U.S. Pat. No. 5,225,976, which issued to tawil, discloses an Automated Health Benefit Processing System close to U.S. Pat. No. 5,519,607.

U.S. Pat. No. 4,817,050, which issued to Komatsu, et al., discloses a Database System. A database system is provided in a network system capable of exchanging medical data, including at least image data and key data associated therewith, and can store and retrieve the medical data via the network system. The database system has first and second data file devices and a file management device. The first data file device stores image data supplied via the network system in a first rewritable storage. The second data file device stores image data transferred from the first storage in a non-rewritable second storage. The file management device has an index data storage for storing the key data, supplied via the network system, and memory addresses of image data, which correspond to the key data, on the first and second storages in correspondence with each other, and manages storing and reading of the image data in and from the first and second data file devices.

Although a lot of inventions have been created in an attempt to provide healthcare providers with an effective and efficient information management system, none of the invention specifically provide healthcare providers with an information management system to help healthcare provider to effectively and efficiently secure reimbursement from those patients if all the payments for services rendered by healthcare providers to those patients are not paid by insurance carriers, if any.

What is needed then is a letter communication method, an apparatus and a computer program product for a healthcare provider to effectively manage and secure final reimbursement process from a patient.

Accordingly, it is a principal object of my invention to provide a letter communication method for a healthcare provider to effectively expedite reimbursement process from a patient.

It is a further object of my invention to provide an apparatus for a healthcare provider to effectively expedite reimbursement process from a patient.

It is a still further object of my invention to provide a computer program product for a healthcare provider to effectively expedite reimbursement process from a patient.

It is a further object of my invention to provide a method for a healthcare provider to effectively manage the necessary and timely communication with a patient, who owes money for the past service provided by the healthcare provider to the patient.

It is a still further object of my invention to provide an apparatus for a healthcare provider to effectively manage the necessary and timely communication with a patient, who owes money for the past service provided by the healthcare provider to the patient.

It is a still further object of my invention to provide a computer program product for a healthcare provider to effectively manage the necessary and timely communication with a patient, who owes money for the past service provided by the healthcare provider to the patient.

### SUMMARY OF THE INVENTION

According to my present invention I have provided a letter communication method and apparatus for a healthcare provider to effectively expedite reimbursement process from a patient. The letter communication method comprises various steps. These steps include (a) gathering current information of a patient of a healthcare provider, (b) exporting the current information by the healthcare provider to a processing center, (c) updating historical information of the patient existing at the processing center to the current information, (d) categorizing the patient into a group, (e) processing the current information of the patient, (f) generating a processed information, (g) reloading the processed information back to the healthcare provider, (h) producing the letter by the healthcare provider, (i) sending the letter to the patient by the healthcare provider, and (j) updating the current information of the patient existing at the healthcare provider to the processed information.

The steps (a)-(k) can be repeated for as many times as desired by the healthcare provider to check the payment status of a patient.

The step (a) of the letter communication method further comprises updating the payment receipt, calculating the account balance due, calculating the current balance due, and setting the current balance due date for the current balance due.

The step (b) of the letter communication method further comprises encoding the current information to generate an encoded information at the healthcare provider, and decoding the encoded information to generate the current information at the processing center.

The step (e) of the letter communication method further comprises identifying a payment method chosen by the patient based on the current information, calculating a past due period based on the current balance due date, and generating the letter according to a pre-defined formula. The pre-defined formula has at least the payment method and the past due period as two variables.

According to my present invention I have also provided an apparatus for a healthcare provider to effectively expedite reimbursement process from a patient. The apparatus includes (a) means for gathering a current information of the patient of the healthcare provider, (b) means for exporting the current information by the healthcare provider to a processing center, (c) means for updating a historical information of the patient existing at the processing center to the current information, (d) means for categorizing the patient into a group, (e) means for processing the current information of the patient, (f) means for generating a processed information, (g) means for reloading the processed information back to the healthcare provider, (h) means for producing the letter by the healthcare provider, (i) means for sending the letter to the patient by the healthcare provider, and (j) means for updating the current information of the patient existing at the healthcare provider to the processed information.

The means for gathering a current information of the patient of the healthcare provider further comprises means for updating the payment receipt, means for calculating the account balance due, means for calculating the current balance due, and means for setting the current balance due date for the current balance due.

The means for exporting the current information by the healthcare provider to a processing center further comprises means for encoding the current information to generate an encoded information at the healthcare provider, and means for decoding the encoded information to generate the current information at the processing center.

The means for processing the current information of the patient further comprises means for identifying a payment method chosen by the patient based on the current information, means for calculating a past due period based on the current balance due date, and means for generating the letter according to a pre-defined formula. The predefined formula has at least the payment method and the past due period as two variables.

According to my present invention I have further a computer program product recorded on a computer readable medium for a method for a healthcare provider to effectively manage and secure reimbursement process from a patient. The computer program product includes (a) computer readable means for gathering a current information of the patient of the healthcare provider, (b) computer readable means for exporting the current information by the healthcare provider to a processing center, (c) computer readable means for updating a historical information of the patient existing at the processing center to the current information, (d) computer readable means for categorizing the patient into a group, (e) computer readable means for processing the current information of the patient, (f) computer readable means for generating a processed information, (g) computer readable means for reloading the processed information back to the healthcare provider, (h) computer readable means for producing the letter by the healthcare provider, (i) computer readable means for sending the letter to the patient by the healthcare provider, and (j) computer readable means for updating the current information of the patient existing at the healthcare provider to the processed information.

The computer readable means for gathering a current information of the patient of the healthcare provider further comprises computer readable means for updating the payment receipt, computer readable means for calculating the account balance due, means for calculating the current balance due, and computer readable means for setting the current balance due date for the current balance due.

The computer readable means for exporting the current information by the healthcare provider to a processing center further comprises computer readable means for encoding the current information to generate an encoded information at the healthcare provider, and computer readable means for decoding the encoded information to generate the current information at the processing center.

The computer readable means for processing the current information of the patient further comprises computer readable means for identifying a payment method chosen by the patient based on the current information, computer readable means for calculating a past due period based on the current balance due date, and computer readable means for generating the letter according to a pre-defined formula. The predefined formula has at least the payment method and the past due period as two variables.

In another embodiment, I have also provided a letter communication method for a healthcare provider to effectively expedite reimbursement process from a patient. The letter communication method comprises (a) gathering a current information of the patient of the healthcare provider, (b) categorizing the patient into a group, (c) processing the current information of the patient, (d) generating a processed information, the processed information including a letter to the patient, (e) producing the letter, (f) sending the letter to the patient, and (g) updating the current information of the patient.

The steps (a)-(g) of the letter communication method can be repeated for as many time as wanted and for as often as needed.

The step (c) of the letter communication method further comprises identifying a payment method chosen by the patient based on the current information of the patient, calculating a past due period based on the current balance due date, and generating the letter according to a pre-defined formula. The pre-defined formula has at least the payment method and the past due period as variables.

The letter that is generated by the letter communication method informs the patient the current information and a future action that the healthcare provider will take at a future date.

In another embodiment, I have also provided an apparatus for a healthcare provider to effectively expedite reimbursement process from a patient. The apparatus comprises (a) means for gathering a current information of the patient of the healthcare provider, (b) means for categorizing the patient into a group, (c) means for processing the current information of the patient, (d) means for generating a processed information, the processed information including a letter to the patient, (e) means for producing the letter, (f) means for sending the letter to the patient, and (g) means for updating the current information of the patient.

The means for processing the current information of the patient of the apparatus further includes means for processing the current information of the patient identifying a payment method chosen by the patient based on the current information of the patient, means for calculating a past due period based on the current balance due date, and means for generating the letter according to a pre-defined formula. The pre-defined formula has at least the payment method and the past due period as variables.

The letter that is generated by the apparatus informs the patient the current information and a future action that the healthcare provider will take at a future date.

In another embodiment, I have further provided a computer program product for a healthcare provider to effectively expedite reimbursement process from a patient. The computer program product comprises (a) computer readable means for gathering a current information of the patient of the healthcare provider, (b) computer readable means for categorizing the patient into a group, (c) computer readable means for processing the current information of the patient, (d) computer readable means for generating a processed information, the processed information including a letter to the patient, (e) computer readable means for producing the letter, (f) computer readable means for sending the letter to the patient, and (g) computer readable means for updating the current information of the patient.

The computer readable means for processing the current information of the patient of the apparatus further comprises computer readable means for processing the current information of the patient identifying a payment method chosen by the patient based on the current information of the patient, computer readable means for calculating a past due period based on the current balance due date, and computer readable means for generating the letter according to a pre-defined formula. The pre-defined formula has at least the payment method and the past due period as variables.

The letter that is generated by the computer program product informs the patient the current information and a future action that the healthcare provider will take at a future date.

### DESCRIPTION OF THE DRAWINGS

Other features of my invention will become more evident from a consideration of the following detailed description of my patent drawings, as follows:

FIG. 1 illustrates a flow diagram of a letter communication method for a healthcare provider to effectively manage and expedite reimbursement process from a patient;

FIG. 2 is a flow diagram showing the detail procedures of categorizing a patient;

FIG. 3 demonstrates a flow diagram of a letter generating procedure for a patient in the commercial PPO & HMO group;

FIG. 4 demonstrates a flow diagram of a letter generating procedure for a patient in the Medicare/Self-pay group;

FIG. 5 demonstrates a flow diagram of a letter generating procedure for a patient in with a monthly pay plan;

FIG. 6 shows a second embodiment of a letter communication method for a healthcare provider to effectively manage and expedite reimbursement process from a patient; and

FIG. 7 presents an apparatus for a healthcare provider to effectively manage and expedite reimbursemet process from a patient.

### DETAILED DESCRIPTION OF THE PREFERRED EMBODIMENT

Referring now to the drawings, the present invention discloses a letter communication method, an apparatus, and a computer program product for a healthcare provider to effectively expedite reimbursement process from a patient.

The purpose of the present invention is to provide healthcare providers, primarily hospitals, with a systematic series of written communications to their patients to promote, accelerate, and increase payments due from them. This complex process involving a group of separate and distinct letters is engineered to insure that patients are fully informed about the status of their account with the healthcare provider that provided services to them. The underlying principal is that most people are honest and will pay their bills if they are fully informed about their account status. This is critical in healthcare because there are other entities in addition to the patient who can effect the patient's account with the healthcare provider. Such groups include third party commercial insurance carriers, Medicare and Medicaid governmental bodies, Workman's Compensation processors, etc. If uninformed patients suspect that these other entities have not fulfilled their obligations, patients will be reluctant and probably unwilling to make payments themselves. This is a very common dynamic in healthcare resulting in significant accounts receivable problems for healthcare providers. This process improves cash recoveries, reduces collection costs, fosters better patient relations, and improves community image. It serves not only as a collection mechanism but also as a public relations tool.

By dynamically engaging patients with a scientific, uniform, consistent, and timely series of letter communications, patients are kept informed about their ongoing relationship with the healthcare provider, from their initial visit through to final account settlement. However, to be effective the letter communication must be punctual, and applied religiously over time. Breakdowns or delays in the delivery of the data that triggers the letters, or the sending of the letters themselves will disrupt the message continuity and reduce overall effectiveness. Such breakdowns and lack of message continuity are what best describes the letter communication processes currently in place at most healthcare provider sites. Most, probably all, healthcare providers send some sort of letter communication/series to their patients from time-to-time, but none employ the rigorous discipline described here.

While the main benefit of the letter communication is increased and accelerated reimbursement from patients, a significant ancillary benefit is the minimal demand it places on the healthcare provider's technical resources to implement and operate. These resources, irrespective of the organization's size and location, are usually fully allocated to the maintenance of other operations. To function properly and yield maximum benefit the letter communication requires a complex discipline to “trigger” the correct letter to the correct patient at the correct time. The vendor, not the healthcare provider, is responsibility for managing this task. The healthcare provider is required only to export and forward a pre-defined set of “raw” information from their legacy management system to the vendor. This is the “lowest common denominator” of such systems. The information required by the letter communication can be exported from them with relatively little cost in both money and employee time.

The “raw” information exported from the healthcare provider's legacy computer software system amounts to a mirror of their entire accounts receivable. It includes complete account history information, all UB-92 and HCFA-1500 billings, payments, and related patient account activity. It works as follows:

1) The healthcare provider exports samples of the raw information that will be uploaded to the vendor. The vendor then “maps” the information to verify that it contains all information necessary to trigger the letters, and can be accurately uploaded into the vendor's data warehouse.

2) Complete historical account information is then exported and transferred/uploaded to the vendor. The physical transfer is preferable via the vendor's secure HIPPA compliant Internet portal. Once at the vendor's site the information is imported into a proprietary data warehouse engineered by the vendor. These histories include all previous account information up to the time of the upload.

3) Immediately after all account histories are uploaded to the vendor the healthcare provider must begin daily exports and uploads of ongoing billings, payments, and related account activity. This insures that the vendor's data warehouse is current and in sync with the healthcare provider's system.

4) The vendor then automatically triggers the letter communication via its proprietary system integrated into the data warehouse.

5) The letter communication activity detail is then logged, formatted to the healthcare provider's legacy systems specification, and downloaded back to the healthcare provider to be imported into their legacy system.

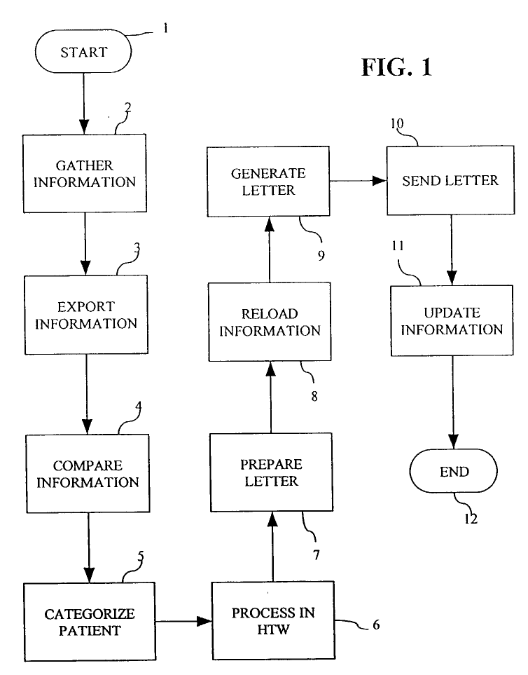

Referring now to FIG. 1, which illustrates a flow diagram of a letter communication method for a healthcare provider to effectively expedite reimbursement process from a patient. The procedure starts at block 1, and immediate proceeds to block 2. At block 2, the procedure gathers all the necessary information needed by the letter communication method, and proceeds to block 3. The necessary information includes at least a payment method chosen by the patient to pay for the healthcare services rendered by the healthcare providers, a balance due from the patient, a current amount due from the patient, a current due date of the current amount due from the patient, a most recent payment received from the patient and the receipt date for that payment. At block 3, the procedure exports the necessary information needed by the letter communication method from the healthcare provider to a processing center, and proceeds to block 4. The processing center can either be an integrated part of the healthcare provider that is controlled by the healthcare provider or an independent contract of the healthcare provider. The necessary information is usually sent to the processing center via a secured connection. At block 4, the procedure updates the information on the processing center related to the patient of the heathcare provider to the current information received by the processing center from the healthcare provider, and proceeds to block 5. The processing center usually, although not necessarily, keeps a copy of the most recent history information of these necessary information from the healthcare provider. The processing center will compare the historical information it kept to the new information received from the healthcare provider, and update the historical information if necessary. At block 5, the procedure categorizes the patient into one of three patient groups based on the insurance information the patient has provided to the healthcare provider, and proceeds to block 6. These three groups include a commercial PPO & HMO group, a Medicare & Self-pay group, and an insufficient insurance information group. The categorization can either be done by the healthcare provider or by the processing center. At block 6, the procedure processes all the information at a data warehouse on the processing center, and proceeds to block 7. The procedure decides which letter template, from a pool of letter templates, is to be generated and sent to the patient based on the information from the healthcare provider. The processing center has a group of letter templates, each of which deals with a different situation. For example, an initial letter template is to be converted into an initial letter by the processing center to the patient to inform the patient that the patient has no insurance and shall be responsible for the whole amount of the service provided by the healthcare provider. Another initial letter template is to be converted into another initial letter by the processing center to the patient to inform the patient that the patient's primary insurance has been paid, and the patient's secondary insurance has been billed. Another letter template is to be converted into another letter by the processing center to the patient to inform the patient that no payment from any insurance carriers has been received by the healthcare provider, the patient is responsible for paying the service that provided to the patient by the healthcare provider. Another letter template is to be converted into another letter by the processing center to the patient to inform the patient that a professional collection agency will be involved if no payment is received by the healthcare provider at a deadline date. At block 7, the procedure prepares a letter based on the letter template, and proceeds to block 8. At block 8, the procedure reloads all the information along with the letter back to the healthcare provider, and proceeds to block 9. At block 9, the healthcare provider generates the letter prepared by the processing center and proceeds to block 10. At block 10, the procedure sends the letter to the patient, and proceeds to block 11. At block 11, the procedure updates the information related to the patient to keep it current, and proceeds to block 12. The procedure is able to update the information on a regular basis to keep the information as current as possible. At block 12, the procedure ends right there.

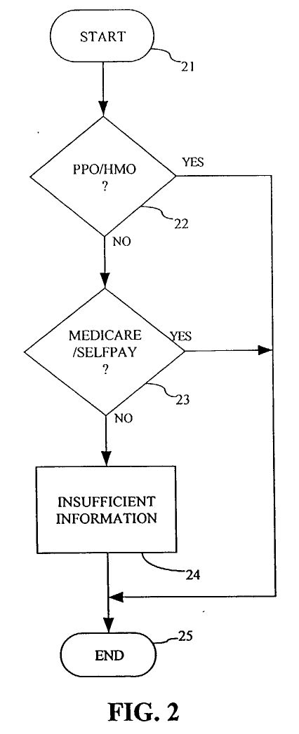

Referring now to FIG. 2, which is a flow diagram showing the detail procedures of categorizing a patient. A procedure starts at block 21 and proceeds immediately to block 22. At block 22, a check is conducted to decide whether the patient has at least a commercial insurance carrier. If YES, the procedure categorizes the patient as a member of the commercial PPO/IMO group, and proceeds to block 25. Returning to block 22, if NO, the procedure proceeds to block 23. At block 23, a check is conducted to decide whether the patient has a Medicare coverage or is self-pay. If YES, the procedure categorizes the patient as a member of the Medicare/Self-pay group, and proceeds to block 25. Returning to block 23, if NO, the procedure proceeds to block 24. At block 24, the procedure concludes that the patient has insufficient insurance information, and proceeds to block 25. At block 25, the procedure ends right there.

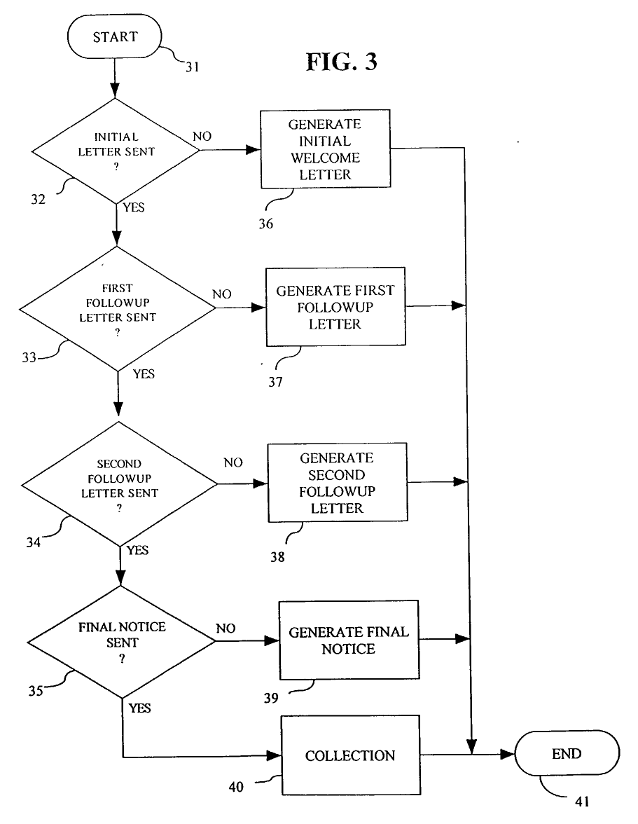

Referring now to FIG. 3, which demonstrates a flow diagram of a letter generating procedure for a patient in the commercial PPO & HMO group. A procedure starts at block 31 and proceeds immediately to block 32. At block 32, a check is conducted to decide if an initial letter has already been sent to the patient. If NO, the procedure proceeds to block 36. At block 36, the procedure generates an initial welcome letter to the patient and proceeds to block 41. The initial welcome letter informs the patient that the patient's insurance carrier of the record has been billed. The initial welcome letter serves an information letter to the patient to inform the status of the patient's account, and a tool to check if the patient provided the right insurance carrier for the billing. The initial letter is usually sent to the patient within a short period of time from the date the healthcare provider provided service to the patient. Returning to block 32, if YES, the procedure proceeds to block 33. At block 33, a check is conducted to decide if a first followup letter has been sent to the patient. If NO, the procedure proceeds to block 37. At block 37, the procedure generates a first followup letter to the patient, and proceeds to block 41. The followup letter informs the patient that no payment has been received from the insurance carrier within the time frame required by the state law, and the patient is responsible for the payment. Returning to block 33, if YES, the procedure proceeds to block 34. At block 34, a check is conducted to decide if a second followup letter has been sent to the patient. If NO, the procedure proceeds to block 38. At block 38, the procedure generates a second followup letter to the patient, and proceeds to block 41. Returning to block 34, if YES, the procedure proceeds to block 35. At block 35, a check is conducted to decide if a final notice has been sent to the patient. If NO, the procedure proceeds to block 39. At block 39, the procedure generates a final notice to the patient, and proceeds to block 41. Returning to block 35, if YES, the procedure proceeds to block 40. At block 40, the procedure generates a collection letter to the patient, and proceeds to block 41. At block 41, the procedure ends right there.

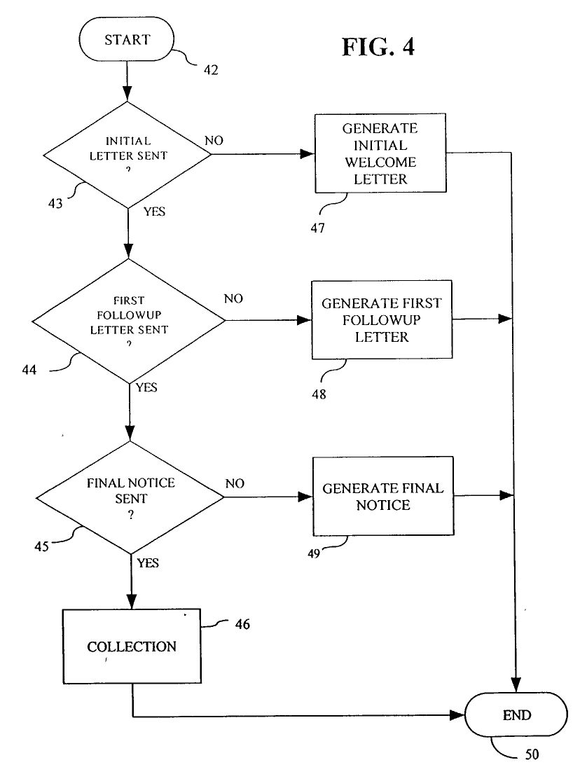

Referring now to FIG. 4, which demonstrates a flow diagram of a letter generating procedure for a patient in the Medicare/Self-pay group. A procedure starts at block 42 and proceeds immediately to block 43. At block 43, a check is conducted to decide if an initial letter has already been sent to the patient. If NO, the procedure proceeds to block 47. At block 47, the procedure generates an initial welcome letter to the patient and proceeds to block 50. The initial welcome letter informs the patient that the patient's insurance carrier of the record has been billed. The initial welcome letter serves an information letter to the patient to inform the status of the patient's account, and a tool to check if the patient provided the right insurance carrier for the billing. The initial letter is usually sent to the patient within a short period of time from the date the healthcare provider provided service to the patient. Returning to block 43, if YES, the procedure proceeds to block 44. At block 44, a check is conducted to decide if a first followup letter has been sent to the patient. If NO, the procedure proceeds to block 48. At block 48, the procedure generates a first followup letter to the patient, and proceeds to block 50. The followup letter informs the patient that no payment has been received from the insurance carrier within the time frame required by the state law, and the patient is responsible for the payment. Returning to block 44, if YES, the procedure proceeds to block 45. At block 45, a check is conducted to decide if a second followup letter has been sent to the patient. If NO, the procedure proceeds to block 49. At block 49, the procedure generates a second followup letter to the patient, and proceeds to block 50. Returning to block 45, if YES, the procedure proceeds to block 46. At block 46, the procedure generates a collection letter to the patient, and proceeds to block 50. At block 50, the procedure ends right there.

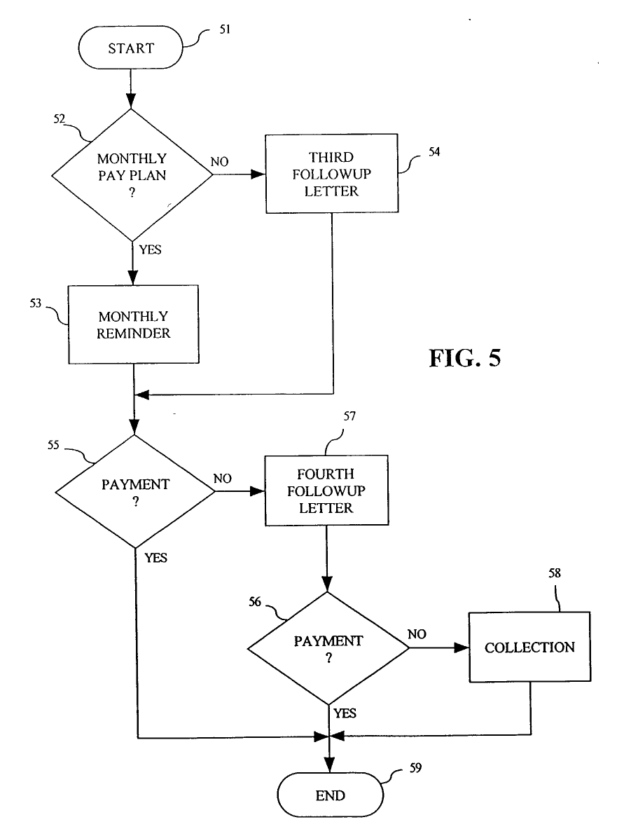

Referring now to FIG. 5, which demonstrates a flow diagram of a letter generating procedure for a patient in with a monthly pay plan. At procedure starts at block 51 and proceeds immediately to block 52. At block 52, a check is conducted to decide whether the patient is under a monthly pay plan. If NO, the procedure proceeds to block 54. At block 54, the procedure generates a third followup letter, and proceeds to block 55. The third followup letter informs the patient that no payment has been received from the patient, the patient needs to pay the balance due within a certain period of time. Returning to block 52, if YES, the procedure proceeds to block 53. At block 53, the procedure generates a monthly reminder to the patient to remind the patient about the monthly payment due, and proceeds to block 55. At block 55, a check is conducted to decide if a payment has been received from the patient by the healthcare provider. If YES, the procedure proceeds to block 59. Returing to block 55, if NO, the procedure proceeds to block 57. At block 57, the procedure generates a fourth followup letter, and proceeds to block 56. At block 56, a check is conducted to decide whether any payment is made by the patient. If YES, proceeds to block 59. Returning to block 56, if NO, the procedure proceeds to block 58. At block 58, the procedure generates a collection letter informing the patient that a professional collection agency will be involved if no payment is received by the healthcare provider at a future payment due date.

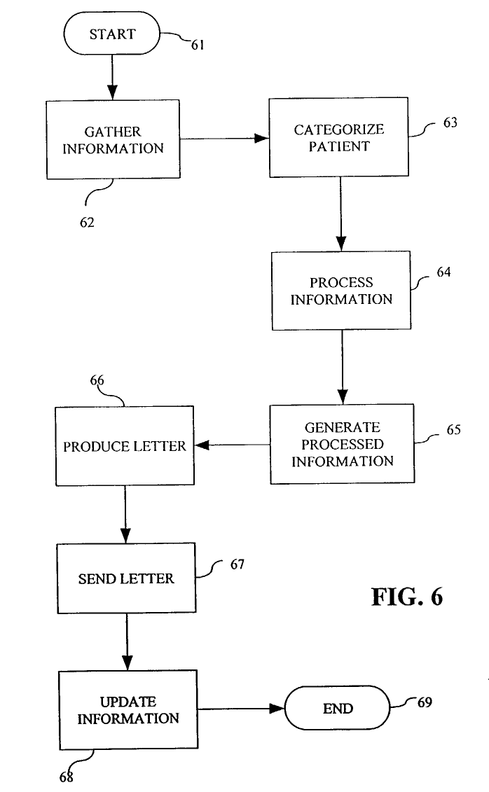

Referring now to FIG. 6, which shows a second embodiment of a letter communication method for a healthcare provider to effectively expedite reimbursement process from a patient. A procedure starts at block 61 and proceeds immediately to block 62. At block 62, the procedure gather all the necessary information about the patient, and proceeds to block 63. Those necessary information includes the patient's payment method, insurance information, account balance, current amount due, current payment due date, a latest payment received from the patient, etc. At block 63, the procedure categorizes the patient into a patient group, and proceeds to block 64. Patient group can be defined freely by the healthcare provider depending on the operating policy of the healthcare provider. At block 64, the procedure processes information of the patent according to a pre-defined process and/or formula, and proceeds to block 65. At block 65, the procedure generates a processed information based on the information provided by the healthcare provider, and proceeds to block 66. The processed information includes a letter generated by the process to the patient based on various information from the healthcare provider. At block 66, the procedure produces the letter to the patient, and proceeds to block 67. At block 67, the procedure sends the letter to the patient, and proceeds to block 68. At block 68, the procedure updates the information of the patient at the healthcare provider, and proceeds to block 69. At block 69, the procedure ends right there.

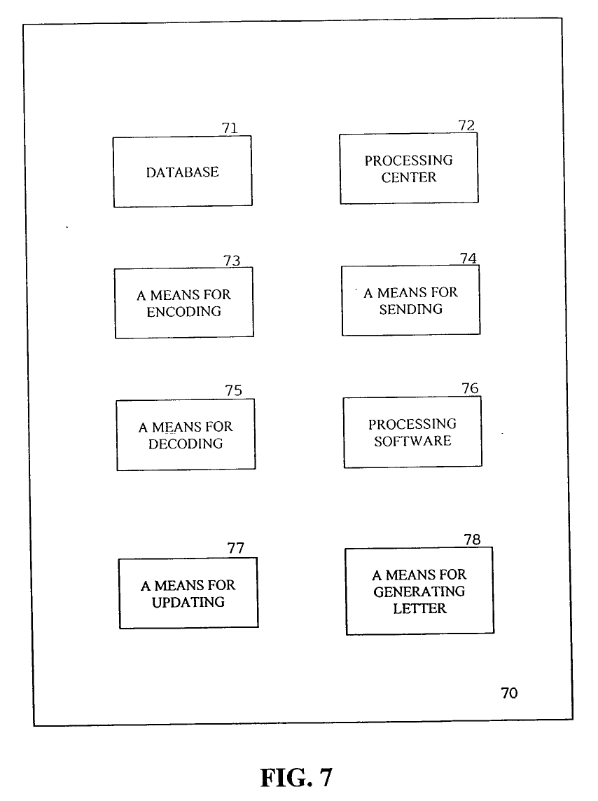

Referring now to FIG. 7, which presents an apparatus 70 for a healthcare provider to effectively expedite reimbursemet process from a patient. The apparatus 70 has a database at the healthcare provider 71. The database is updated by the healthcare provider from time to time. The database has at least a current information of the patient. The current information includes at least a payment method of the patient, a balance due amount of the patient, a current balance due amount of the patient, and a payment due date of the patient. The apparatus also has a processing center 72, means for encoding information 73, means for sending information within the apparatus 74, means for decoding information 75, a processing software 76, means for updating the current information according to the updated information 77, means for generating the letter to the patient 78, and a connecting means for connecting the database 71, the processing center 72, the means for encoding information 73, the means for sending information 74, the means for decoding information 75, the processing software 76, the means for updating 77, and the means for generating the letter 78 together electronically.

Hence, the present invention provides a letter communication method for a healthcare provider to effectively expedite reimbursement process from a patient.

The present invention also provides an apparatus for a healthcare provider to effectively expedite reimbursement process from a patient.

The present invention further provides a computer program product for a healthcare provider to effectively expedite reimbursement process from a patient.

The present invention still further provides a method for a healthcare provider to effectively manage the necessary and timely communication with a patient, who owes money for the past service provided by the healthcare provider to the patient.

The present invention still further provides an apparatus for a healthcare provider to effectively manage the necessary and timely communication with a patient, who owes money for the past service provided by the healthcare provider to the patient.

The present invention still further provides a computer program product for a healthcare provider to effectively manage the necessary and timely communication with a patient, who owes money for the past service provided by the healthcare provider to the patient.

As various possible embodiments may be made in the above invention for use for different purposes and as various changes might be made in the embodiments and methods above set forth, it is understood that all of the above matters here set forth or shown in the accompanying drawings are to be interpreted as illustrative and not in a limiting sense.

I claim:

1. A letter communication method for a healthcare provider to effectively expedite reimbursement process from a patient, said letter communication method comprises:
(a) gathering current account receivable information of said patient of said healthcare provider, said current account receivable information being updated by said healthcare provider on a regular basis;
(b) exporting said current account receivable information by said healthcare provider to a processing center;
(c) comparing historical account receivable information of said patient existing at said processing center to said current account receivable information;
(d) categorizing said patient into one of three groups, said three groups being a commercial PPO/HMO group, a Medicare/Self Pay group, and an Insufficient Insurance Information group;
(e) processing said current account receivable information of said patient to generate a processed information, said processed information triggering a letter to said patient based on a current account receivable amount and number of days between current date and a first billing date, said first billing date being a date that an initial letter being sent to said patient, said initial letter being one of three kinds of initial letters, said three kinds of initial letters being a first kind of initial letter if said patient being in said commercial PPO/HMO group, said patient having a commercial insurance carrier, said first kind of initial letter being an initial welcome letter to said patient indicating that said commercial insurance carrier being billed on behalf of said patient, a second kind of initial letter if said patient being in said Medicare/Self Pay group, said second kind of initial letter being one of five initial letters, said five initial letters being a first initial letter when said patient having a Medicare insurance carrier and a secondary insurance carrier, said Medicare insurance carrier having paid and said secondary insurance carrier being billed, a second initial letter when said patient having a primary insurance carrier and a secondary insurance carrier, said primary insurance carrier having paid and said secondary insurance carrier being billed, a third initial letter when said patient having a Medicare insurance carrier but having no secondary insurance carrier, said Medicare insurance carrier having paid and said patient being billed, a fourth initial letter when said patient having a primary insurance carrier and a Medicare insurance carrier as a secondary insurance carrier, said primary insurance carrier having paid and said Medicare insurance carrier being billed, and a fifth initial letter when said patient having no insurance carrier, said patient being billed, and a third kind of initial letter if said patient being in said Insufficient Insurance Information group, said third kind of initial letter being one of two initial letters, said two initial letters being a sixth initial letter when said patient having provided incomplete insurance carrier information, said patient being requested for more information about said insurance carrier by said healthcare provider, a seventh initial letter when said patient having provided insurance carrier information to indicate an insurance carrier, said patient being requested for more information by said insurance carrier, and an eighth initial letter reminding said patient a monthly payment being due at a certain date of every month, when said patient having agreed to make said monthly payment on said certain date of every month;
(f) preparing said letter to said patient;
(g) reloading said processed information back to said healthcare provider;
(h) producing said letter by said healthcare provider;
(i) sending said letter to said patient by said healthcare provider; and
(j) updating said current account receivable information.

2. The letter communication method in claim 1, wherein steps (a)-(j) can be repeated.

3. The letter communication method in claim 1, wherein said letter informs said patient that all payments have been received when said current account receivable amount is zero and said patient has never been informed before.

4. The letter communication method in claim 1, wherein said letter informs said patient that said current account receivable amount has not been paid by said commercial insurance carrier and said patient needs to contact said commercial insurance carrier, when said current account receivable amount is not zero, and said number of days exceeds a first group of pre-defined numbers, said first group of pre-defined numbers being 50-56.

5. The letter communication method in claim 1, wherein said letter informs said patient that said current account receivable amount has not been paid by said commercial insurance carrier and said patient is responsible for payment of said current account receivable amount, when said current account receivable amount is not zero, and said number of days exceeds a second group of pre-defined numbers, said second group of predefined numbers being 78-84.

6. The letter communication method in claim 1, wherein said letter informs said patient that said current account receivable amount has not been paid by said patient and a professional collection agency will be involved, when said current account receivable amount is not zero, and said number of days exceeds a third group of pre-defined numbers, said third group of pre-defined numbers being 99-105.

7. The letter communication method in claim 1, wherein said letter informs said patient that said Medicare insurance carrier has paid, said current account receivable amount has not been paid by said secondary insurance carrier and said patient needs to contact said secondary insurance carrier, when said Medicare insurance carrier has paid, said secondary insurance carrier has not paid, said current account receivable amount is not zero, and said number of days exceeds a fourth group of pre-defined numbers, said fourth group of pre-defined numbers being 50-56.

8. The letter communication method in claim 1, wherein said letter informs said patient that said primary insurance carrier has paid, said current account receivable amount has not been paid by said secondary insurance carrier and said patient needs to contact said secondary insurance carrier, when said primary insurance carrier has paid, said secondary insurance carrier has not paid, said current account receivable amount is not zero, and said number of days exceeds a fifth group of pre-defined numbers, said fifth group of pre-defined numbers being 50-56.

9. The letter communication method in claim 1, wherein said letter informs said patient that said current account receivable amount has not been paid by said secondary insurance carrier and said patient is responsible for payment of said current account receivable amount, when said primary insurance carrier has paid, said secondary insurance carrier has not paid, said current account receivable amount is not zero, and said number of days exceeds a sixth group of pre-defined numbers, said sixth group of predefined numbers being 74-78.

10. The letter communication method in claim 1, wherein said letter informs said patient that said current account receivable amount has not been paid by said secondary insurance carrier and said patient is responsible for payment of said current account receivable amount, when said Medicare insurance carrier has paid, said secondary insurance carrier has not paid, said current account receivable amount is not zero, and said number of days exceeds a seventh group of pre-defined numbers, said seventh group of predefined numbers being 78-84.

11. The letter communication method in claim 1, wherein said letter informs said patient that said current account receivable amount has not been paid by said patient and said patient needs to make payment to cover said current account receivable amount, when said Medicare insurance carrier has paid, said patient has no secondary insurance carrier, said current account receivable amount is not zero, and said number of days exceeds an eighth group of pre-defined numbers, said eighth group of pre-defined numbers being 28.

12. The letter communication method in claim 1, wherein said letter informs said patient that said current account receivable amount has not been paid by said patient and a professional collection agency will be involved, when said Medicare insurance carrier has paid, said patient has no secondary insurance carrier, said current account receivable amount is not zero, and said number of days exceeds a ninth group of pre-defined numbers, said ninth group of pre-defined numbers being 63-70.

13. The letter communication method in claim 1, wherein said letter informs said patient that said current account receivable amount has not been paid by said patient and a professional collection agency will be involved, when said patient has no insurance carrier, said current account receivable amount is not zero, and said number of days exceeds a tenth group of pre-defined numbers, said tenth group of pre-defined numbers being 22-28.

14. The letter communication method in claim 1, wherein said letter informs said patient that said current account receivable amount has not been paid by said patient and said patient is responsible for said current account receivable amount, when said current account receivable amount is not zero, no response is received from said patient regarding to said incomplete insurance information and said number of days exceeds an eleventh group of pre-defined numbers, said eleventh group of pre-defined numbers being 14-21.

15. The letter communication method in claim 1, wherein said letter informs said patient that said current account receivable amount has not been paid by said patient and said patient is responsible for said current account receivable amount, when said current account receivable amount is not zero, no response is received from said patient regarding to said incomplete insurance information and said number of days exceeds an twelfth group of pre-defined numbers, said twelfth group of pre-defined numbers being 42-49.

16. The letter communication method in claim 1, wherein said letter informs said patient that said current account receivable amount has not been paid by said patient and a professional collection agency will be involved, when said patient is self-pay, said current account receivable amount is not zero, and said number of days exceeds a thirteenth group of pre-defined numbers, said thirteenth group of pre-defined numbers being 56-63.

17. The letter communication method in claim 1, wherein said letter informs said patient that said current account receivable amount has not been paid by said patient and said patient needs to provide said insurance carrier with said more information, when said patient has provided insufficient insurance information to said insurance carrier, said current account receivable amount is not zero, no response is received from said patient regarding to said insufficient insurance information and said number of days exceeds an fourteenth group of pre-defined numbers, said fourteenth group of pre-defined numbers being 28-35.

18. The letter communication method in claim 1, wherein said letter informs said patient that said current account receivable amount has not been paid by said patient and a professional collection agency will be involved, when said patient has provided insufficient insurance information to said insurance carrier, said current account receivable amount is not zero, no response is received from said patient regarding to said insufficient insurance information and said number of days exceeds an fifteenth group of pre-defined numbers, said fifteenth group of pre-defined numbers being 53-63.

19. The letter communication method in claim 1, wherein said letter informs said patient that said monthly payment is past due, when said patient agrees to make said monthly payment and no said monthly payment is received by said healthcare provider at said certain date.

20. The letter communication method in claim 1, wherein said letter informs said patient that said monthly payment has not been paid by said patient and a professional collection agency will be involved, when said current account receivable amount is not zero, and said number of days exceeds a sixteenth group of pre-defined numbers, said sixteenth group of pre-defined numbers being 15.

21. A letter communication method for a healthcare provider to effectively expedite reimbursement process from a patient, said letter communication method comprises:
(a) gathering current information of said patient of said healthcare provider, said current information being updated by said healthcare provider on a regular basis, said current information including an account balance due, a past due period and a payment method of said patient, said payment method being a lump sum payment method or a monthly pay plan method, said monthly pay plan method having a pre-defined monthly payment date and a pre-defined monthly payment amount, said pre-defined monthly payment date and said pre-defined monthly payment amount being defined by said healthcare provider;
(b) exporting said current information by said healthcare provider to a processing center;
(c) updating historical information of said patient existing at said processing center to said current information;
(d) categorizing said patient into one of three groups, said three groups being a commercial PPO/HMO group, a Medicare/Self Pay group, and an Insufficient Insurance Information group;
(e) processing said current information of said patient;
(f) generating a processed information, said processed information including a letter to said patient, said letter being generated by said processing center based on said current information of said patient;
(g) preparing said letter to said patient;
(h) reloading said processed information back to said healthcare provider, said processed information including said letter to said patient;
(i) producing said letter by said healthcare provider;
(j) sending said letter to said patient by said healthcare provider; and
(k) updating said current information of said patient existing at said healthcare provider to said processed information.

22. The letter communication method in claim 21, wherein steps (a)-(k) can be repeated.

23. The letter communication method in claim 21, wherein said letter informs said patient that all payments have been received when said account balance due is zero and said patient has never been informed before.

24. The letter communication method in claim 21, wherein said letter informs said patient that said account balance due has not been paid by a commercial insurance carrier and said patient needs to contact said commercial insurance carrier, when said account balance due is not zero, said patient has said commercial insurance carrier, and said past due period is within a first group of pre-defined numbers, said first group of pre-defined numbers being defined by either said healthcare provider or said processing center.

25. The letter communication method in claim 21, wherein said letter informs said patient that said account balance due has not been paid by a commercial insurance carrier and said patient is responsible for payment of said account balance due, when said account balance due is not zero, said patient has claimed to have said commercial insurance, and said past due period is within a second group of pre-defined numbers, said second group of pre-defined numbers being defined by either said healthcare provider or said processing center.

26. The letter communication method in claim 21, wherein said letter informs said patient that said account balance due has not been paid by said patient and a professional collection agency will be involved, when said account balance due is not zero, and said past due period is within a third group of pre-defined numbers, said third group of predefined numbers being defined by either said healthcare provider or said processing center.

27. The letter communication method in claim 21, wherein said letter informs said patient to make said pre-defined monthly payment amount at said pre-defined monthly payment date, when said patient is under said monthly pay plan method.

28. The letter communication method in claim 21, wherein said letter informs said patient that said pre-defined monthly payment amount has not been received by paid healthcare provider since said pre-defined payment date, and a professional collection agency will be involved, when said patient is under said monthly pay plan method and no said pre-defined monthly payment amount has been received by said healthcare provider since said pre-defined monthly payment date.

29. A letter communication method for a healthcare provider to effectively expedite reimbursement process from a patient, said letter communication method comprises:
(a) gathering a current information of said patient of said healthcare provider, said current information being updated by said healthcare provider on a regular basis, said information including a payment receipt, an account balance due, a current balance due, and a current balance due date for said current balance due;
(b) exporting said current information by said healthcare provider to a processing center;
(c) updating a historical information of said patient existing at said processing center to said current information;
(d) categorizing said patient into a group, said group being defined by either said healthcare provider or said processing center;
(e) processing said current information of said patient;
(f) generating a processed information, said processed information including a letter to said patient, said letter being generated by said processing center based on said current information of said patient;
(g) reloading said processed information back to said healthcare provider, said processed information including said letter to said patient;
(h) producing said letter by said healthcare provider;
(i) sending said letter to said patient by said healthcare provider; and
(j) updating said current information of said patient existing at said healthcare provider to said processed information.

30. The letter communication method in claim 29, wherein steps (a)-(j) can be repeated.

31. The letter communication method in claim 29, wherein said step (a) further comprises
(a) updating said payment receipt;
(b) calculating said account balance due;
(c) calculating said current balance due; and
(d) setting said current balance due date for said current balance due.

32. The letter communication method in claim 29, wherein said step (b) further comprises
(a) encoding said current information to generate an encoded information at said healthcare provider; and
(b) decoding said encoded information to generate said current information at said processing center.

33. The letter communication method in claim 29, wherein said step (e) further comprises
(a) identifying a payment method chosen by said patient based on said current information, said payment method being either a lump sum payment method or a monthly pay plan method;
(b) calculating a past due period based on said current balance due date; and
(c) generating said letter according to a pre-defined formula, said pre-defined formula having said payment method and said past due period as two variables.

34. A letter communication method for a healthcare provider to effectively expedite reimbursement process from a patient, said letter communication method comprises:
(a) gathering a current information of said patient of said healthcare provider;
(b) categorizing said patient into a group;
(c) processing said current information of said patient;
(d) generating a processed information, said processed information including a letter to said patient;
(e) producing said letter;
(f) sending said letter to said patient; and
(g) updating said current information of said patient.

35. The letter communication method in claim 34, wherein steps (a)-(g) can be repeated.

36. The letter communication method in claim 35, wherein said step (c) further comprises
(a) identifying a payment method chosen by said patient based on said current information of said patient;
(b) calculating a past due period based on said current balance due date; and
(c) generating said letter according to a pre-defined formula, said pre-defined formula having at least said payment method and said past due period as variables.

37. The letter communication method in claim 36, wherein said letter informs said patient said current information and a future action of said healthcare provider at a future date.

38. An apparatus for a healthcare provider to effectively expedite reimbursement process from a patient, said apparatus comprises:
(a) means for gathering a current account receivable information of said patient of said healthcare provider, said current account receivable information being updated by said healthcare provider on a regular basis;
(b) means for exporting said current account receivable information by said healthcare provider to a processing center;
(c) means for comparing historical account receivable information of said patient existing at said processing center to said current account receivable information;
(d) means for categorizing said patient into one of three groups, said three groups being a commercial PPO/HMO group, a Medicare/Self Pay group, and an Insufficient Insurance Information group;
(e) means for processing said current account receivable information of said patient to generate a processed information, said processed information triggering a letter to said patient based on a current account receivable amount and number of days between current date and a first billing date, said first billing date being a date that an initial letter being sent to said patient, said initial letter being one of three kinds of initial letters, said three kinds of initial letters being a first kind of initial letter if said patient being in said commercial PPO/HMO group, said patient having a commercial insurance carrier, said first kind of initial letter being an initial welcome letter to said patient indicating that said commercial insurance carrier being billed on behalf of said patient, a second kind of initial letter if said patient being in said Medicare/Self Pay group, said second kind of initial letter being one of five initial letters, said five initial letters being a first initial letter when said patient having a Medicare insurance carrier and a secondary insurance carrier, said Medicare insurance carrier having paid and said secondary insurance carrier being billed, a second initial letter when said patient having a primary insurance carrier and a secondary insurance carrier, said primary insurance carrier having paid and said secondary insurance carrier being billed, a third initial letter when said patient having a Medicare insurance carrier but having no secondary insurance carrier, said Medicare insurance carrier having paid and said patient being billed, a fourth initial letter when said patient having a primary insurance carrier and a Medicare insurance carrier as a secondary insurance carrier, said primary insurance carrier having paid and said Medicare insurance carrier being billed, and a fifth initial letter when said patient having no insurance carrier, said patient being billed, and a third kind of initial letter if said patient being in said Insufficient Insurance Information group, said third kind of initial letter being one of two initial letters, said two initial letters being a sixth initial letter when said patient having provided incomplete insurance carrier information, said patient being requested for more information about said insurance carrier by said healthcare provider, a seventh initial letter when said patient having provided insurance carrier information to indicate an insurance carrier, said patient being requested for more information by said insurance carrier, and an eighth initial letter reminding said patient a monthly payment being due at a certain date of every month, when said patient having agreed to make said monthly payment on said certain date of every month;
(f) means for preparing said letter to said patient;
(g) means for reloading said processed information back to said healthcare provider;
(h) means for producing said letter by said healthcare provider;
(i) means for sending said letter to said patient by said healthcare provider; and
(j) means for updating said current account receivable information.

39. The apparatus in claim 38, wherein said letter informs said patient that all payments have been received when said current account receivable amount is zero and said patient has never been informed before.

40. The apparatus in claim 38, wherein said letter informs said patient that said current account receivable amount has not been paid by said commercial insurance carrier and said patient needs to contact said commercial insurance carrier, when said current account receivable amount is not zero, and said number of days exceeds a first group of pre-defined numbers, said first group of pre-defined numbers being 50-56.

41. The apparatus in claim 38, wherein said letter informs said patient that said current account receivable amount has not been paid by said commercial insurance carrier and said patient is responsible for payment of said current account receivable amount, when said current account receivable amount is not zero, and said number of days exceeds a second group of pre-defined numbers, said second group of predefined numbers being 78-84.

42. The apparatus in claim 38, wherein said letter informs said patient that said current account receivable amount has not been paid by said patient and a professional collection agency will be involved, when said current account receivable amount is not zero, and said number of days exceeds a third group of pre-defined numbers, said third group of pre-defined numbers being 99-105.

43. The apparatus in claim 38, wherein said letter informs said patient that said Medicare insurance carrier has paid, said current account receivable amount has not been paid by said secondary insurance carrier and said patient needs to contact said secondary insurance carrier, when said Medicare insurance carrier has paid, said secondary insurance carrier has not paid, said current account receivable amount is not zero, and said number of days exceeds a fourth group of pre-defined numbers, said fourth group of pre-defined numbers being 50-56.

44. The apparatus in claim 38, wherein said letter informs said patient that said primary insurance carrier has paid, said current account receivable amount has not been paid by said secondary insurance carrier and said patient needs to contact said secondary insurance carrier, when said primary insurance carrier has paid, said secondary insurance carrier has not paid, said current account receivable amount is not zero, and said number of days exceeds a fifth group of pre-defined numbers, said fifth group of pre-defined numbers being 50-56.

45. The apparatus in claim 38, wherein said letter informs said patient that said current account receivable amount has not been paid by said secondary insurance carrier and said patient is responsible for payment of said current account receivable amount, when said primary insurance carrier has paid, said secondary insurance carrier has not paid, said current account receivable amount is not zero, and said number of days exceeds a sixth group of pre-defined numbers, said sixth group of predefined numbers being 74-78.

46. The apparatus in claim 38, wherein said letter informs said patient that said current account receivable amount has not been paid by said secondary insurance carrier and said patient is responsible for payment of said current account receivable amount, when said Medicare insurance carrier has paid, said secondary insurance carrier has not paid, said current account receivable amount is not zero, and said number of days exceeds a seventh group of pre-defined numbers, said seventh group of predefined numbers being 78-84.

47. The apparatus in claim 38, wherein said letter informs said patient that said current account receivable amount has not been paid by said patient and said patient needs to make payment to cover said current account receivable amount, when said Medicare insurance carrier has paid, said patient has no secondary insurance carrier, said current account receivable amount is not zero, and said number of days exceeds an eighth group of pre-defined numbers, said eighth group of pre-defined numbers being 28.

48. The apparatus in claim 38, wherein said letter informs said patient that said current account receivable amount has not been paid by said patient and said patient needs to provide said insurance carrier with said more information, when said patient has provided insufficient insurance information to said insurance carrier, said current account receivable amount is not zero, no response is received from said patient regarding to said insufficient insurance information and said number of days exceeds an fourteenth group of pre-defined numbers, said fourteenth group of pre-defined numbers being 28-35.

49. The apparatus in claim 38, wherein said letter informs said patient that said monthly payment is past due, when said patient agrees to make said monthly payment and no said monthly payment is received by said healthcare provider at said certain date.

50. The apparatus in claim 38, wherein said letter informs said patient that said monthly payment has not been paid by said patient and a professional collection agency will be involved, when said current account receivable amount is not zero, and said number of days exceeds a sixteenth group of pre-defined numbers, said sixteenth group of pre-defined numbers being 15.

51. An apparatus for a healthcare provider to effectively expedite reimbursement process from a patient, said apparatus comprises:
(a) means for gathering a current information of said patient of said healthcare provider, said current information being updated by said healthcare provider on a regular basis, said current information including an account balance due, a past due period and a payment method of said patient, said payment method being a lump sum payment method or a monthly pay plan method, said monthly pay plan method having a pre-defined monthly payment date and a pre-defined monthly payment amount, said pre-defined monthly payment date and said pre-defined monthly payment amount being defined by said healthcare provider;
(b) means for exporting said current information by said healthcare provider to a processing center;
(c) means for updating historical information of said patient existing at said processing center to said current information;
(d) means for categorizing said patient into one of three groups, said three groups being a commercial PPO/HMO group, a Medicare/Self Pay group, and an Insufficient Insurance Information group;
(e) means for processing said current information of said patient;
(f) means for generating a processed information, said processed information including a letter to said patient, said letter being generated by said processing center based on said current information of said patient;
(g) means for preparing said letter to said patient;
(h) means for reloading said processed information back to said healthcare provider, said processed information including said letter to said patient;
(i) means for producing said letter by said healthcare provider;
(j) means for sending said letter to said patient by said healthcare provider; and
(k) means for updating said current information of said patient existing at said healthcare provider to said processed information.

52. The apparatus in claim 51, wherein said letter informs said patient that all payments have been received when said account balance due is zero and said patient has never been informed before.

53. The apparatus in claim 51, wherein said letter informs said patient that said account balance due has not been paid by a commercial insurance carrier and said patient needs to contact said commercial insurance carrier, when said account balance due is not zero, said patient has said commercial insurance carrier, and said past due period is within a first group of pre-defined numbers, said first group of pre-defined numbers being defined by either said healthcare provider or said processing center.

54. The apparatus in claim 51, wherein said letter informs said patient that said account balance due has not been paid by a commercial insurance carrier and said patient is responsible for payment of said account balance due, when said account balance due is not zero, said patient has claimed to have said commercial insurance, and said past due period is within a second group of pre-defined numbers, said second group of pre-defined numbers being defined by either said healthcare provider or said processing center.

55. The apparatus in claim 51, wherein said letter informs said patient that said account balance due has not been paid by said patient and a professional collection agency will be involved, when said account balance due is not zero, and said past due period is within a third group of pre-defined numbers, said third group of pre-defined numbers being defined by either said healthcare provider or said processing center.

56. The apparatus in claim 51, wherein said letter informs said patient to make said pre-defined monthly payment amount at said pre-defined monthly payment date, when said patient is under said monthly pay plan method.

57. The apparatus in claim 51, wherein said letter informs said patient that said predefined monthly payment amount has not been received by paid healthcare provider since said pre-defined payment date, and a professional collection agency will be involved, when said patient is under said monthly pay plan method and no said pre-defined monthly payment amount has been received by said healthcare provider since said predefined monthly payment date.

58. An apparatus for a healthcare provider to effectively expedite reimbursement process from a patient, said apparatus comprises
(a) means for gathering a current information of said patient of said healthcare provider, said current information being updated by said healthcare provider on a regular basis, said information including a payment receipt, an account balance due, a current balance due, and a current balance due date for said current balance due;
(b) means for exporting said current information by said healthcare provider to a processing center;
(c) means for updating a historical information of said patient existing at said processing center to said current information;
(d) means for categorizing said patient into a group, said group being defined by either said healthcare provider or said processing center;
(e) means for processing said current information of said patient;
(f) means for generating a processed information, said processed information including a letter to said patient, said letter being generated by said processing center based on said current information of said patient;
(g) means for reloading said processed information back to said healthcare provider, said processed information including said letter to said patient;
(h) means for producing said letter by said healthcare provider;
(i) means for sending said letter to said patient by said healthcare provider; and
(j) means for updating said current information of said patient existing at said healthcare provider to said processed information.

59. The apparatus in claim 58, wherein said means for gathering said current information of said patient of said healthcare provider further comprises
(a) means for updating said payment receipt;
(b) means for calculating said account balance due;
(c) means for calculating said current balance due; and
(d) means for setting said current balance due date for said current balance due.

60. The apparatus in claim 58, wherein said means for exporting said current information by said healthcare provider to said processing center further comprises
(a) means for encoding said current information to generate an encoded information at said healthcare provider; and
(b) means for decoding said encoded information to generate said current information at said processing center.

61. The apparatus in claim 58, wherein said means for processing said current information of said patient further comprises
(a) means for identifying a payment method chosen by said patient based on said current information, said payment method being either a lump sum payment method or a monthly pay plan method;
(b) means for calculating a past due period based on said current balance due date; and
(c) means for generating said letter according to a pre-defined formula, said predefined formula having said payment method and said past due period as two variables.

62. An apparatus for a healthcare provider to effectively expedite reimbursement process from a patient, said apparatus comprises:
(a) means for gathering a current information of said patient of said healthcare provider;
(b) means for categorizing said patient into a group;
(c) means for processing said current information of said patient;
(d) means for generating a processed information, said processed information including a letter to said patient;
(e) means for producing said letter;
(f) means for sending said letter to said patient; and
(g) means for updating said current information of said patient.

63. The apparatus in claim 62, wherein said means for processing said current information of said patient further comprises
(a) means for identifying a payment method chosen by said patient based on said current information of said patient;
(b) means for calculating a past due period based on said current balance due date; and
(c) means for generating said letter according to a pre-defined formula, said predefined formula having at least said payment method and said past due period as variables.

64. The apparatus in claim 63, wherein said letter informs said patient said current information and a future action of said healthcare provider at a future date.

65. An apparatus for a healthcare provider to effectively expedite reimbursement process from a patient, said apparatus comprises:
(a) a database at said healthcare provider, said database being updated from time to time, said database having at least a current information of said patient, said current information having a payment method of said patient, a balance due amount of said patient, a current balance due amount of said patient, and a payment due date of said patient;
(b) a processing center;
(b) means for encoding said current information of said patient into an encoded information at said healthcare provider;
(c) means for sending said encoded information to said processing center by said healthcare provider;
(d) means for decoding said encoded information into said current information at said processing center;
(e) a processing software, said processing software being on said processing center, said processing software capable of generating an updated information, said updated information including a letter, said letter being generated by said processing software based on said current information, said letter including a pre-defined part of said current information and a future action of said healthcare provider;
(f) means for encoding said updated information into an encoded updated information at said processing center;
(g) means for sending said encoded updated information to said healthcare provider by said processing center;
(h) means for decoding said encoded updated information into said updated information at said healthcare provider;
(i) means for updating said current information according to said updated information;
(j) means for generating said letter to said patient; and
(k) a connecting means for connecting said database, said processing center, said means for encoding said current information, said means for sending said encoded information, said means for decoding said encoded information, said processing software, said means for encoding said updated information, said means for sending encoded updated information, said means for decoding said encoded updated information, said means for updating, and said means for generating said letter together electronically.

66. A computer program product recorded on a computer readable medium for a method for a healthcare provider to effectively expedite reimbursement process from a patient, said computer program product comprises:
(a) computer readable means for gathering a current account receivable information of said patient of said healthcare provider, said current account receivable information being updated by said healthcare provider on a regular basis;
(b) computer readable means for exporting said current account receivable information by said healthcare provider to a processing center;
(c) computer readable means for comparing historical account receivable information of said patient existing at said processing center to said current account receivable information;
(d) computer readable means for categorizing said patient into one of three groups, said three groups being a commercial PPO/HMO group, a Medicare/Self Pay group, and an Insufficient Insurance Information group;
(e) computer readable means for processing said current account receivable information of said patient to generate a processed information, said processed information triggering a letter to said patient based on a current account receivable amount and number of days between current date and a first billing date, said first billing date being a date that an initial letter being sent to said patient, said initial letter being one of three kinds of initial letters, said three kinds of initial letters being a first kind of initial letter if said patient being in said commercial PPO/HMO group, said patient having a commercial insurance carrier, said first kind of initial letter being an initial welcome letter to said patient indicating that said commercial insurance carrier being billed on behalf of said patient, a second kind of initial letter if said patient being in said Medicare/Self Pay group, said second kind of initial letter being one of five initial letters, said five initial letters being a first initial letter when said patient having a Medicare insurance carrier and a secondary insurance carrier, said Medicare insurance carrier having paid and said secondary insurance carrier being billed, a second initial letter when said patient having a primary insurance carrier and a secondary insurance carrier, said primary insurance carrier having paid and said secondary insurance carrier being billed, a third initial letter when said patient having a Medicare insurance carrier but having no secondary insurance carrier, said Medicare insurance carrier having paid and said patient being billed, a fourth initial letter when said patient having a primary insurance carrier and a Medicare insurance carrier as a secondary insurance carrier, said primary insurance carrier having paid and said Medicare insurance carrier being billed, and a fifth initial letter when said patient having no insurance carrier, said patient being billed, and a third kind of initial letter if said patient being in said Insufficient Insurance Information group, said third kind of initial letter being one of two initial letters, said two initial letters being a sixth initial letter when said patient having provided incomplete insurance carrier information, said patient being requested for more information about said insurance carrier by said healthcare provider, a seventh initial letter when said patient having provided insurance carrier information to indicate an insurance carrier, said patient being requested for more information by said insurance carrier, and an eighth initial letter reminding said patient a monthly payment being due at a certain date of every month, when said patient having agreed to make said monthly payment on said certain date of every month;
(f) computer readable means for preparing said letter to said patient;
(g) computer readable means for reloading said processed information back to said healthcare provider;
(h) computer readable means for producing said letter by said healthcare provider;
(i) computer readable means for sending said letter to said patient by said healthcare provider; and
(j) computer readable means for updating said current account receivable information.

67. The computer program product in claim 66, wherein said letter informs said patient that all payments have been received when said current account receivable amount is zero and said patient has never been informed before.

68. The computer program product in claim 66, wherein said letter informs said patient that said current account receivable amount has not been paid by said commercial insurance carrier and said patient needs to contact said commercial insurance carrier, when said current account receivable amount is not zero, and said number of days exceeds a first group of pre-defined numbers, said first group of pre-defined numbers being 50-56.

69. The computer program product in claim 66, wherein said letter informs said patient that said current account receivable amount has not been paid by said commercial insurance carrier and said patient is responsible for payment of said current account receivable amount, when said current account receivable amount is not zero, and said number of days exceeds a second group of pre-defined numbers, said second group of predefined numbers being 78-84.

70. The computer program product in claim 66, wherein said letter informs said patient that said current account receivable amount has not been paid by said patient and a professional collection agency will be involved, when said current account receivable amount is not zero, and said number of days exceeds a third group of pre-defined numbers, said third group of pre-defined numbers being 99-105.

71. The computer program product in claim 66, wherein said letter informs said patient that said Medicare insurance carrier has paid, said current account receivable amount has not been paid by said secondary insurance carrier and said patient needs to contact said secondary insurance carrier, when said Medicare insurance carrier has paid, said secondary insurance carrier has not paid, said current account receivable amount is not zero, and said number of days exceeds a fourth group of pre-defined numbers, said fourth group of pre-defined numbers being 50-56.

72. The computer program product in claim 66, wherein said letter informs said patient that said primary insurance carrier has paid, said current account receivable amount has not been paid by said secondary insurance carrier and said patient needs to contact said secondary insurance carrier, when said primary insurance carrier has paid, said secondary insurance carrier has not paid, said current account receivable amount is not zero, and said number of days exceeds a fifth group of pre-defined numbers, said fifth group of pre-defined numbers being 50-56.

73. The computer program product in claim 66, wherein said letter informs said patient that said current account receivable amount has not been paid by said secondary insurance carrier and said patient is responsible for payment of said current account receivable amount, when said primary insurance carrier has paid, said secondary insurance carrier has not paid, said current account receivable amount is not zero, and said number of days exceeds a sixth group of pre-defined numbers, said sixth group of predefined numbers being 74-78.

74. The computer program product in claim 66, wherein said letter informs said patient that said current account receivable amount has not been paid by said secondary insurance carrier and said patient is responsible for payment of said current account receivable amount, when said Medicare insurance carrier has paid, said secondary insurance carrier has not paid, said current account receivable amount is not zero, and said number of days exceeds a seventh group of pre-defined numbers, said seventh group of predefined numbers being 78-84.

75. The computer program product in claim 66, wherein said letter informs said patient that said current account receivable amount has not been paid by said patient and said patient needs to make payment to cover said current account receivable amount, when said Medicare insurance carrier has paid, said patient has no secondary insurance carrier, said current account receivable amount is not zero, and said number of days exceeds an eighth group of pre-defined numbers, said eighth group of pre-defined numbers being 28.

76. The computer program product in claim 66, wherein said letter informs said patient that said current account receivable amount has not been paid by said patient and said patient needs to provide said insurance carrier with said more information, when said patient has provided insufficient insurance information to said insurance carrier, said current account receivable amount is not zero, no response is received from said patient regarding to said insufficient insurance information and said number of days exceeds an fourteenth group of pre-defined numbers, said fourteenth group of pre-defined numbers being 28-35.

77. The computer program product in claim 66, wherein said letter informs said patient that said monthly payment is past due, when said patient agrees to make said monthly payment and no said monthly payment is received by said healthcare provider at said certain date.

78. The computer program product in claim 66, wherein said letter informs said patient that said monthly payment has not been paid by said patient and a professional collection agency will be involved, when said current account receivable amount is not zero, and said number of days exceeds a sixteenth group of pre-defined numbers, said sixteenth group of pre-defined numbers being 15.

79. A computer program product recorded on a computer readable medium for a method for a healthcare provider to effectively expedite reimbursement process from a patient, said computer program product comprises:
(a) computer readable means for gathering a current information of said patient of said healthcare provider, said current information being updated by said healthcare provider on a regular basis, said current information including an account balance due, a past due period and a payment method of said patient, said payment method being a lump sum payment method or a monthly pay plan method, said monthly pay plan method having a pre-defined monthly payment date and a pre-defined monthly payment amount, said pre-defined monthly payment date and said pre-defined monthly payment amount being defined by said healthcare provider;
(b) computer readable means for exporting said current information by said healthcare provider to a processing center;
(c) computer readable means for updating historical information of said patient existing at said processing center to said current information;
(d) computer readable means for categorizing said patient into one of three groups, said three groups being a commercial PPO/HMO group, a Medicare/Self Pay group, and an Insufficient Insurance Information group;
(e) computer readable means for processing said current information of said patient;
(f) computer readable means for generating a processed information, said processed information including a letter to said patient, said letter being generated by said processing center based on said current information of said patient;
(g) computer readable means for preparing said letter to said patient;
(h) computer readable means for reloading said processed information back to said healthcare provider, said processed information including said letter to said patient;
(i) computer readable means for producing said letter by said healthcare provider;
(j) computer readable means for sending said letter to said patient by said healthcare provider; and
(k) computer readable means for updating said current information of said patient existing at said healthcare provider to said processed information.

80. The computer program product in claim 79, wherein said letter informs said patient that all payments have been received when said account balance due is zero and said patient has never been informed before.

81. The computer program product in claim 79, wherein said letter informs said patient that said account balance due has not been paid by a commercial insurance carrier and said patient needs to contact said commercial insurance carrier, when said account balance due is not zero, said patient has said commercial insurance carrier, and said past due period is within a first group of pre-defined numbers, said first group of pre-defined numbers being defined by either said healthcare provider or said processing center.

82. The computer program product in claim 79, wherein said letter informs said patient that said account balance due has not been paid by a commercial insurance carrier and said patient is responsible for payment of said account balance due, when said account balance due is not zero, said patient has claimed to have said commercial insurance, and said past due period is within a second group of pre-defined numbers, said second group of pre-defined numbers being defined by either said healthcare provider or said processing center.

83. The computer program product in claim 79, wherein said letter informs said patient that said account balance due has not been paid by said patient and a professional collection agency will be involved, when said account balance due is not zero, and said past due period is within a third group of pre-defined numbers, said third group of predefined numbers being defined by either said healthcare provider or said processing center.

84. The computer program product in claim 79, wherein said letter informs said patient to make said pre-defined monthly payment amount at said pre-defined monthly payment date, when said patient is under said monthly pay plan method.

85. The computer program product in claim 79, wherein said letter informs said patient that said pre-defined monthly payment amount has not been received by paid healthcare provider since said pre-defined payment date, and a professional collection agency will be involved, when said patient is under said monthly pay plan method and no said pre-defined monthly payment amount has been received by said healthcare provider since said pre-defined monthly payment date.

86. A computer program product recorded on a computer readable medium for a method for a healthcare provider to effectively expedite reimbursement process from a patient, said computer program product comprises:
(a) computer readable means for gathering a current information of said patient of said healthcare provider, said current information being updated by said healthcare provider on a regular basis, said information including a payment receipt, an account balance due, a current balance due, and a current balance due date for said current balance due;
(b) computer readable means for exporting said current information by said healthcare provider to a processing center;
(c) computer readable means for updating a historical information of said patient existing at said processing center to said current information;
(d) computer readable means for categorizing said patient into a group, said group being defined by either said healthcare provider or said processing center;
(e) computer readable means for processing said current information of said patient;
(f) computer readable means for generating a processed information, said processed information including a letter to said patient, said letter being generated by said processing center based on said current information of said patient;
(g) computer readable means for reloading said processed information back to said healthcare provider, said processed information including said letter to said patient;
(h) computer readable means for producing said letter by said healthcare provider;
(i) computer readable means for sending said letter to said patient by said healthcare provider; and
(j) computer readable means for updating said current information of said patient existing at said healthcare provider to said processed information.

87. The computer program product in claim 86, wherein said computer readable means for gathering said current information of said patient of said healthcare provider further comprises
(a) computer readable means for updating said payment receipt;
(b) computer readable means for calculating said account balance due;
(c) computer readable means for calculating said current balance due; and
(d) computer readable means for setting said current balance due date for said current balance due.

88. The computer program product in claim 86, wherein said computer readable means for exporting said current information by said healthcare provider to said processing center further comprises
(a) computer readable means for encoding said current information to generate an encoded information at said healthcare provider; and
(b) computer readable means for decoding said encoded information to generate said current information at said processing center.

89. The computer program product in claim 86, wherein said computer readable means for processing said current information of said patient further comprises
(a) computer readable means for identifying a payment method chosen by said patient based on said current information, said payment method being either a lump sum payment method or a monthly pay plan method;
(b) computer readable means for calculating a past due period based on said current balance due date; and
(c) computer readable means for generating said letter according to a pre-defined formula, said pre-defined formula having said payment method and said past due period as two variables.

90. A computer program product recorded on a computer readable medium for a method for a healthcare provider to effectively expedite reimbursement process from a patient, said computer program product comprises:
(a) computer readable means for gathering a current information of said patient of said healthcare provider;
(b) computer readable means for categorizing said patient into a group;
(c) computer readable means for processing said current information of said patient;
(d) computer readable means for generating a processed information, said processed information including a letter to said patient;
(e) computer readable means for producing said letter;
(f) computer readable means for sending said letter to said patient; and
(g) computer readable means for updating said current information of said patient.

91. The computer program product in claim 90, wherein said computer readable means for processing said current information of said patient further comprises
(a) computer readable means for identifying a payment method chosen by said patient based on said current information of said patient;
(b) computer readable means for calculating a past due period based on said current balance due date; and
(c) computer readable means for generating said letter according to a pre-defined formula, said pre-defined formula having at least said payment method and said past due period as variables.

91. The computer program product in claim 91, wherein said letter informs said patient said current information and a future action of said healthcare provider at a future date.

92. A computer program product recorded on a computer readable medium for a method for a healthcare provider to effectively expedite reimbursement process from a patient, said computer program product comprises:
(a) computer readable means for structuring a database at said healthcare provider, said database being updated from time to time, said database having at least a current information of said patient, said current information having a payment method of said patient, a balance due amount of said patient, a current balance due amount of said patient, and a payment due date of said patient;
(b) computer readable means for structuring a processing center;
(b) computer readable means for encoding said current information of said patient into an encoded information at said healthcare provider;
(c) computer readable means for sending said encoded information to said processing center by said healthcare provider;
(d) computer readable means for decoding said encoded information into said current information at said processing center;
(e) computer readable means for generating an updated information on said processing center, said updated information including a letter, said letter being generated by said processing software based on said current information, said letter including a predefined part of said current information and a future action of said healthcare provider;
(f) computer readable means for encoding said updated information into an encoded updated information at said processing center;
(g) computer readable means for sending said encoded updated information to said healthcare provider by said processing center;
(h) computer readable means for decoding said encoded updated information into said updated information at said healthcare provider;
(i) computer readable means for updating said current information according to said updated information; and
(j) computer readable means for generating said letter to said patient.
